(19) United States
(12) Patent Application Publication
(10) Pub. No.: US 2026/0132773 A1
(43) Pub. Date: May 14, 2026

(54) FILM ACTUATOR AND METHOD FOR MANUFACTURING THE SAME

(71) Applicant: ELECTRONICS AND TELECOMMUNICATIONS RESEARCH INSTITUTE, Daejeon (KR)

(72) Inventors: Hunpyo JU, Daejeon (KR); Hye Jin KIM, Daejeon (KR)

(21) Appl. No.: 19/360,626

(22) Filed: Oct. 16, 2025

(30) Foreign Application Priority Data
Nov. 12, 2024 (KR) 10-2024-0160444
Mar. 13, 2025 (KR) 10-2025-0032635

(51) Int. Cl. F03G 7/06

(52) U.S. Cl. CPC F03G 7/06143; F05B 2230/604; F05B 2280/107; F05B 2280/5006

(57) ABSTRACT

Provided is a film actuator. The film actuator includes a substrate, transformation wires disposed on the substrate to be spaced apart in a first direction parallel to the substrate, fixed wires disposed to be spaced apart from the transformation wires in the first direction and disposed on both sides of the transformation wires, respectively, and fixing blocks disposed on the transformation wires and the fixed wires to be spaced apart in a second direction parallel to the substrate and intersecting the first direction. The transformation wires include a shape memory alloy.

### CROSS-REFERENCE TO RELATED APPLICATIONS

This U.S. non-provisional patent application claims priority under 35 U.S.C. § 119 of Korean Patent Application Nos. 10-2024-0160444, filed on Nov. 12, 2024, and 10-2025-0032635, filed on Mar. 13, 2025, the entire contents of which are hereby incorporated by reference.

### BACKGROUND

### 1. Field of the Invention

The present disclosure herein relates to a film actuator and a method for manufacturing the same, and more particularly to a film actuator including a shape memory alloy and a ductile metal, and a method for manufacturing the same.

### 2. Description of Related Art

Recently, in the field of soft robots, there has been increasing interest in developing technologies that are capable of implementing flexible and complex shapes while maintaining a desired shape. Unlike conventional mechanical robots, soft robots have employed soft and flexible materials, and thus they have been capable of being transformed into various shapes. In particular, soft robots have been actively studied since they have the ability to adapt to various external environments in medical applications, implantable devices, and wearable devices. One of the important technical challenges of such soft robots has been a method of fixing and maintaining a specific shape after transformation, and various technologies have been proposed for this purpose.

### SUMMARY

The present disclosure provides a film actuator capable of maintaining a fixed shape without power consumption.

The present disclosure also provides a method for manufacturing a film actuator capable of controlling a desired channel.

An embodiment of the inventive concept provides a film actuator including: a substrate; transformation wires disposed on the substrate to be spaced apart from each other in a first direction parallel to the substrate; fixed wires disposed to be spaced apart from the transformation wires in the first direction and disposed on both sides of the transformation wires, respectively; and fixing blocks disposed on the transformation wires and the fixed wires to be spaced apart from each other in a second direction parallel to the substrate and intersecting the first direction, wherein the transformation wires include a shape memory alloy.

In an embodiment, the transformation wires and the fixed wires may extend in the second direction, respectively.

In an embodiment, a portion of each of the transformation wires and a portion of each of the fixed wires may be exposed between the fixing blocks.

In an embodiment, the shape memory alloy may include nitinol, which is an alloy of nickel and titanium.

In an embodiment, the fixing blocks may include at least one of a photosensitive adhesive, a photosensitive resin, or a thermosetting resin.

In an embodiment, the fixed wires may include at least one of gold, silver, copper, or aluminum.

In an embodiment, each of the transformation wires may have a first thickness in a third direction perpendicular to the substrate, each of the fixed wires may have a second thickness, and the second thickness may be greater than the first thickness.

In an embodiment, the substrate may include at least one of polyethylene terephthalate (PET), polyimide (PI), polyethylene naphthalate (PEN), polydimethylsiloxane (PDMS), or parylene.

In an embodiment, the substrate may include a top surface and a bottom surface opposite to each other, the transformation wire may further include an upper transformation wire disposed on the top surface of the substrate and a lower transformation wire disposed on the bottom surface of the substrate, and a voltage may be selectively applied to the upper transformation wire or the lower transformation wire.

In an embodiment of the inventive concept, a film actuator includes: a substrate; transformation wires disposed on the substrate to be spaced apart from each other in a first direction parallel to the substrate; fixed wires disposed to be spaced apart from the transformation wires in the first direction and disposed on both sides of the transformation wires, respectively; a conductive pattern disposed on the substrate and electrically connected to the transformation wires; and fixing blocks disposed on the transformation wires, the fixed wires, and the conductive pattern to be spaced apart from each other in a second direction parallel to the substrate and intersecting the first direction, wherein each of the transformation wire includes a shape memory alloy, and a portion of each of the transformation wires and a portion of each of the fixed wires are exposed between the fixing blocks.

In an embodiment, the shape memory alloy may include nitinol, which is an alloy of nickel and titanium, and each of the fixed wires may include at least one of gold, silver, copper, or aluminum.

In an embodiment of the inventive concept, a method for manufacturing a film actuator includes: preparing a guide structure including a guide body and projections disposed on the guide body to be spaced apart from each other; placing transformation wires on the guide structure; placing line patterns on the transformation wires and pressing the transformation wires and the line patterns; cutting the line patterns; placing fixed wires on the guide structure to form a wire array structure; and aligning the wire array structure on a substrate.

In an embodiment, the guide body may have a rectangular ring shape having a cavity at a center thereof, the guide body has a first width in a first direction, and the cavity has a second width smaller than the first width in the first direction.

In an embodiment, before the cutting of the line patterns, each of the line patterns may have a third width greater than the first width in the first direction.

In an embodiment, after the cutting of the line patterns, each of the cut line patterns may have a fourth width smaller than the second width in the first direction.

In an embodiment, the aligning of the wire array structure on the substrate may include aligning the substrate so that the substrate is disposed in the cavity.

In an embodiment, the transformation wires may be spaced apart from each other in the first direction and disposed between different projections, and the line patterns may be spaced apart from each other in a second direction intersecting the first direction.

In an embodiment, the forming of the wire array structure may include: placing the fixed wires on both sides of the array of the transformation wires in the first direction to be spaced apart from the transformation wires; and placing the fixed wires to be spaced apart from the cut line patterns.

In an embodiment, the substrate may include a conductive pattern, and the method may further include: attaching the line patterns to the conductive pattern; and forming fixing blocks configured to cover a portion of the conductive pattern, a portion of the transformation wires, and a portion of the fixed wires.

### BRIEF DESCRIPTION OF THE DRAWINGS

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 illustrates a schematic plan view of a film actuator according to embodiments of the inventive concept;

FIG. 2 illustrates cross-sectional views of FIG. 1 taken along line A-A′ and line B-B′ according to embodiments of the inventive concept;

FIG. 3 illustrates a diagram illustrating transformation and restoration of the film actuator according to embodiments of the inventive concept;

FIG. 4 illustrates a plan view of the film actuator according to embodiments of the inventive concept;

FIGS. 5A to 5E illustrate diagrams sequentially illustrating a process of manufacturing the film actuator of FIG. 4 according to embodiments of the inventive concept; and

FIG. 6 illustrates perspective views of multi-channel film actuators according to embodiments of the inventive concept.

### DETAILED DESCRIPTION OF THE INVENTION

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. The thickness and the ratio and the dimension of the element are exaggerated for effective description of the technical contents. As used herein, the term “and/or” includes any and all combinations of one or more of the associated listed items.

Hereinafter, in order to describe the inventive concept more specifically, embodiments according to the inventive concept may be described in detail with reference to the accompanying drawings. In this specification, each phrase such as “A or B,” “at least one of A and B,” “at least one of A or B,” “A, B or C,” “at least one of A, B and C,” and “at least one of A, B, or C” may include any one of the elements listed together in the phrase or all possible combinations thereof. In this specification, terms such as first, second, and the like, indicating an order, may be used to distinguish components performing the same or similar functions from one another, and the numbers may be changed depending on the order in which they are mentioned.

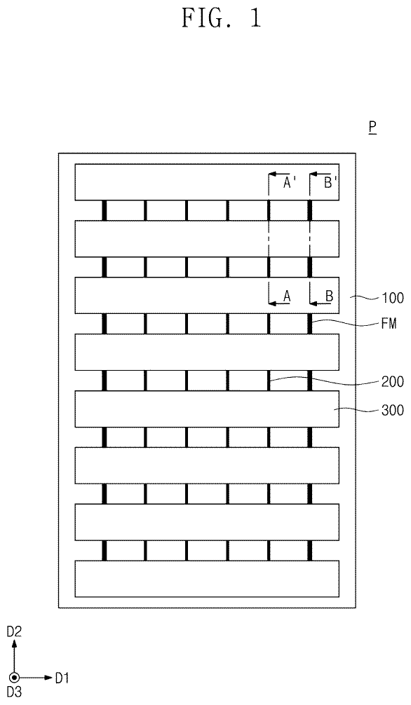

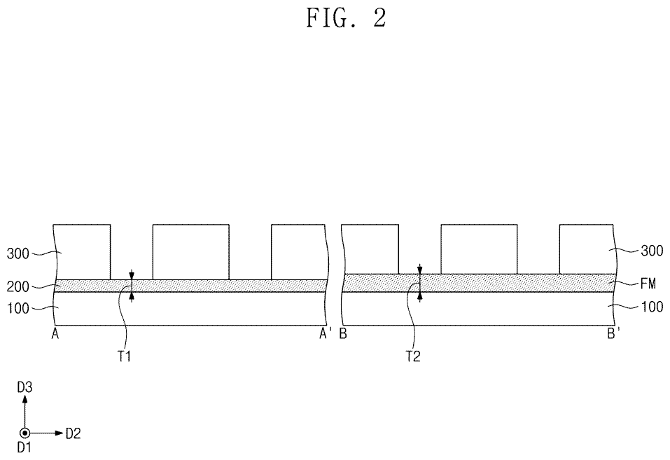

FIG. 1 is a schematic plan view of a film actuator according to embodiments of the inventive concept. FIG. 2 illustrates cross-sectional views of FIG. 1 taken along line A-A′ and line B-B′ according to embodiments of the inventive concept.

Referring to FIGS. 1 and 2, a film actuator P according to an embodiment of the inventive concept may include a substrate 100. The substrate 100 may have a flexible characteristic or a stretchable characteristic, and deformation and restoration may be elastically performed. The substrate 100 may be referred to as a “film substrate” or a “flexible substrate.” The substrate 100 may include at least one of polyethylene terephthalate (PET), polyimide (PI), polyethylene naphthalate (PEN), polydimethylsiloxane (PDMS), or parylene. The film actuator P may be deformed, for example contracted, according to a voltage applied through transistors.

A plurality of transformation wires 200 may be disposed on the substrate 100. Transformation wires 200 may be spaced apart from each other along a first direction D1 parallel to the substrate 100. For example, the transformation wires 200 may be arranged at regular intervals, but are not limited thereto. Each transformation wire 200 may extend along a second direction D2 parallel to the substrate 100 and intersecting the first direction D1. For example, the second direction D2 may intersect the first direction D1. The transformation wire 200 may include, for example, a shape memory alloy (SMA). The shape memory alloy may mean an alloy having a property of returning to a memorized shape before deformation by heating even if the shape is arbitrarily deformed.

The shape memory alloy may include, for example, Nitinol, which is an alloy of nickel and titanium. For example, the shape memory alloy may contract or expand due to heat generated when a current flows through the shape memory alloy. This may vary depending on the type of the shape memory alloy and a shape memory temperature. In this embodiment, the shape memory alloy is exemplified as contracting when the temperature exceeds a predetermined temperature.

The transformation wire 200 may have a property of contracting or expanding when heat is applied. The contraction of the transformation wire 200 may cause bending deformation of the substrate 100. When a voltage is applied to the film actuator P, the transformation wire 200 may contract or expand due to heat generated by a current flowing through the transformation wire 200. In this embodiment, for example, current may flow through the transformation wire 200 so that heat is generated in the transformation wire 200, and the transformation wire 200 may contract when the temperature exceeds a predetermined temperature.

Fixed wires M may be disposed on the substrate 100. In one embodiment, two fixed wires FM may be provided. The fixed wires FM may be spaced apart from the transformation wires 200 in the first direction D1 and may be disposed one at each side of the transformation wires 200. Each fixed wire FM may extend along the second direction D2. However, the inventive concept is not limited thereto, and three or more fixed wires FM may be provided. The fixed wire FM may include a material different from that of the transformation wire 200. The fixed wire FM may include, for example, a metal. The metal may have ductility, which is a property of elongating without breaking or fracturing even when an external force is applied. The metal may include, for example, at least one of gold, silver, copper, or aluminum. As shown in FIG. 2, in a third direction D3, the transformation wire 200 may have a first thickness T1, and the fixed wire FM may have a second thickness T2 greater than the first thickness T1.

When the substrate 100 is deformed due to contraction of the transformation wire 200, the fixed wire FM may also be bent and deformed in the same direction together. For example, a bending stress of the substrate 100 generated by a contraction stress of the transformation wire 200 may be greater than a yield stress of the fixed wires FM. The fixed wire FM may serve to fix the shapes of the transformation wire 200 and the substrate 100 even after bending deformation caused by the transformation wire 200 is completed. This may be due to permanent transformation resulting from plastic deformation of the metal having ductility. Thus, the fixed wire FM may allow the film actuator P to maintain its shape without continuous power consumption. As a result, the film actuator P may be improved in energy efficiency and stability.

A plurality of fixing blocks 300 may be disposed on the substrate 100. The fixing blocks 300 may cover a portion of each of the transformation wires 200 and a portion of each of the fixed wires FM. The fixing blocks 300 may be spaced apart from each other along an extending direction of the transformation wires 200 and the fixed wires FM, i.e., the second direction D2. A portion of each of the transformation wires 200 and a portion of each of the fixed wires FM may be exposed between the fixing blocks 300. The transformation wire 200 and the fixed wire FM may be fixed to the substrate 100 by the fixing blocks 300. The fixing block 300 may be attached to the substrate 100 so that a transformation force of the transformation wire 200 may be directly applied to the substrate 100. The fixing block 300 may include, for example, at least one of a photosensitive adhesive, a photosensitive resin, or a thermosetting resin.

The film actuator P according to the inventive concept may provide a flexible electronic device capable of self-deformation. The film actuator P may have a structure in which the transformation wires 200 including a shape memory alloy and the fixed wires FM including a metal having ductility are combined with the flexible substrate 100. The rigidity of the metal included in the fixed wire FM may be large enough to withstand restoring force due to elasticity of the substrate 100.

When a voltage is applied to the film actuator P and heat is generated in the transformation wire 200, the transformation wire 200 may contract, and since the substrate 100 has a neutral plane, a bending deformation may occur in the direction of the contracted transformation wire 200. Tensile deformation may occur on an opposite surface of the substrate 100 where the bending deformation occurs. The shape memory alloy may have a property of being restored to a memorized shape at a specific temperature even after deformation occurs. Therefore, a voltage may be applied to the transformation wires 200 positioned on the opposite surface of the substrate 100 to restore the substrate 100. When a voltage is applied, the transformation wires 200 disposed on the opposite surface of the substrate 100 may contract so that the film actuator P may be restored to a memorized shape before deformation. Since the transformation wire 200 and the fixed wire FM are disposed on the substrate 100 in consideration of strain of the transformation wire 200 and the fixed wire FM, the film actuator P may have stability even under repeated deformation.

The structure of the film actuator P described above is merely an example, and the number of the transformation wires 200 and the fixing blocks 300, the distance between the transformation wires 200, and the distance between the fixing blocks 300 may be variously changed depending on the structure of an applied display.

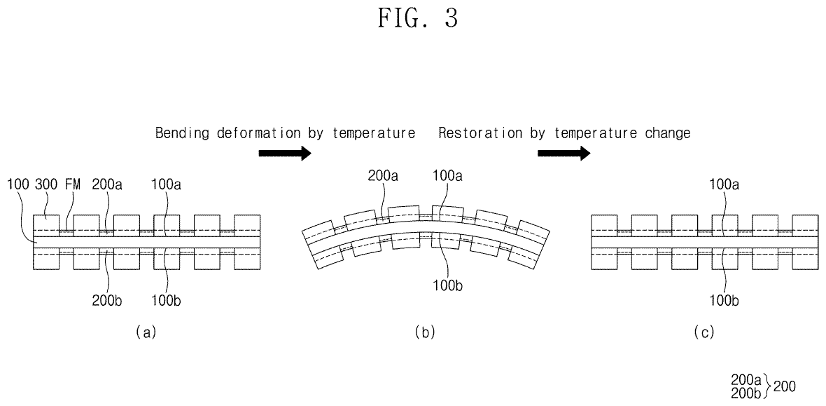

FIG. 3 illustrates a diagram illustrating transformation and restoration of the film actuator according to embodiments of the inventive concept. FIG. 3 schematically illustrates a portion of a film actuator.

Referring to FIG. 3, a film actuator according to one embodiment may include the film actuator P described with reference to FIGS. 1 and 2. The film actuator may include a substrate 100, fixed wires FM, an upper transformation wire 200a, a lower transformation wire 200b, and fixing blocks 300. The substrate 100 may include a top surface 100a and a bottom surface 100b. The upper transformation wire 200a may be disposed on the top surface 100a of the substrate 100. The lower transformation wire 200b may be disposed on the bottom surface 100b of the substrate 100. The upper transformation wire 200a and the lower transformation wire 200b may be the transformation wires 200 described with reference to FIGS. 1 and 2.

The film actuator may have a structure in which the upper and lower transformation wires 200a and 200b, the fixed wires FM, and the fixing blocks 300 are symmetrically disposed on both surfaces of the substrate 100. A voltage may be independently applied to each of the upper transformation wire 200a and the lower transformation wire 200b so that a current may flow therethrough. A voltage may be selectively applied to the upper transformation wire 200a or the lower transformation wire 200b according to a desired contraction direction of the film actuator.

FIG. 3 shows an initial state (a) of the film actuator, a state (b) in which a voltage is applied to the lower transformation wire 200b, and a state (c) in which a voltage is applied to the upper transformation wire 200a so that the film actuator may be restored to its original shape.

Referring to (a), a voltage may be applied to an electrode pad (not shown) connected to the lower transformation wire 200b of the film actuator. When the voltage is applied, a current may flow through the lower transformation wire 200b, and heat may be generated in the lower transformation wire 200b. As the lower transformation wire 200b generates heat, bending deformation (for example, contraction or tension) may occur due to the shape memory alloy of the lower transformation wire 200b. The contraction may occur on the bottom surface 100b of the substrate 100 on which the lower transformation wire 200b is disposed. At the same time, the upper transformation wire 200a may undergo tensile deformation, and the top surface 100a of the substrate 100 may also undergo tensile deformation.

Referring to (b), since the metal of the fixed wire FM may have ductility, when the substrate 100 is deformed, the fixed wire FM may also be bent and deformed in the same direction together. The bending shape of the film actuator may be fixed by the fixed wire FM disposed on the top surface 100a and the bottom surface 100b of the substrate 100. The fixed wire FM may fix the shapes of the transformation wire 200 and the substrate 100 at room temperature even after the bending deformation caused by the transformation wire 200 is completed. Thus, the film actuator P may maintain its shape without continuous power consumption. As a result, the film actuator P may be improved in energy efficiency and stability.

Referring to (c), assuming that the shape memory alloy memorizes the flat shape of (a), the transformed shape memory alloy may be restored to the memorized shape at a specific temperature, so that the entire film actuator may be restored to the original flat shape. This will be described in more detail below.

A voltage may be applied to an electrode pad (not shown) connected to the upper transformation wire 200a of the film actuator. When the voltage is applied, a current may flow through the upper transformation wire 200a, and heat may be generated in the upper transformation wire 200a. As the upper transformation wire 200a generates heat, bending deformation (for example, contraction or tension) may occur due to the shape memory alloy of the upper transformation wire 200a. The contraction may occur on the top surface 100a of the substrate 100 on which the upper transformation wire 200a is disposed. At the same time, the lower transformation wire 200b may undergo tensile deformation, and the bottom surface 100b of the substrate 100 may also undergo tensile deformation. Thus, the film actuator may be restored to the original shape thereof. Such deformation and restoration of the film actuator may be repeatedly performed.

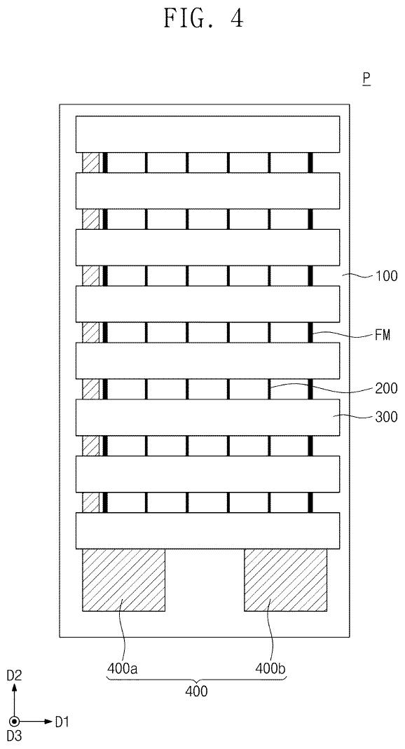

FIG. 4 illustrates a plan view of the film actuator according to embodiments of the inventive concept.

Referring to FIG. 4, a film actuator P′ according to one embodiment may include a conductive pattern 400. The conductive pattern 400 may include a first electrode pad 400a and a second electrode pad 400b. When a voltage is applied to the first electrode pad 400a and the second electrode pad 400b, a current may flow through the connected transformation wire 200, and the transformation wire 200 may generate heat so that a bending deformation may occur in the film actuator P′. Other configurations may be the same as or similar to those described with reference to FIGS. 1 to 3.

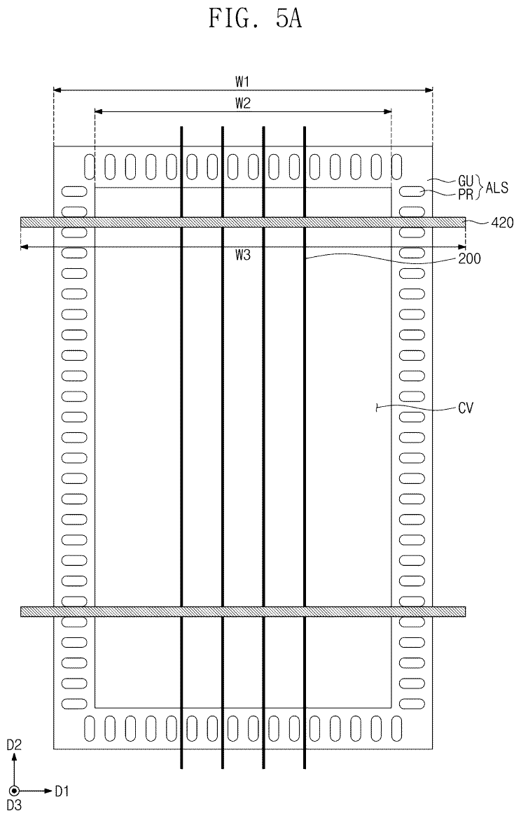

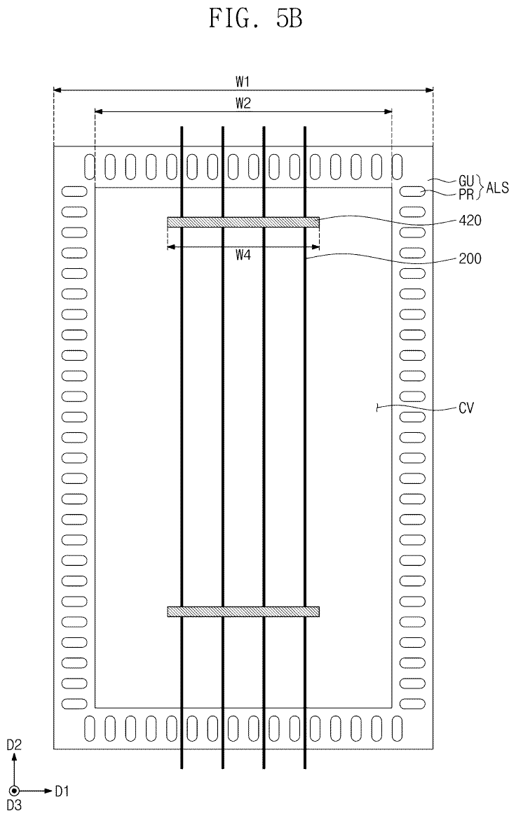

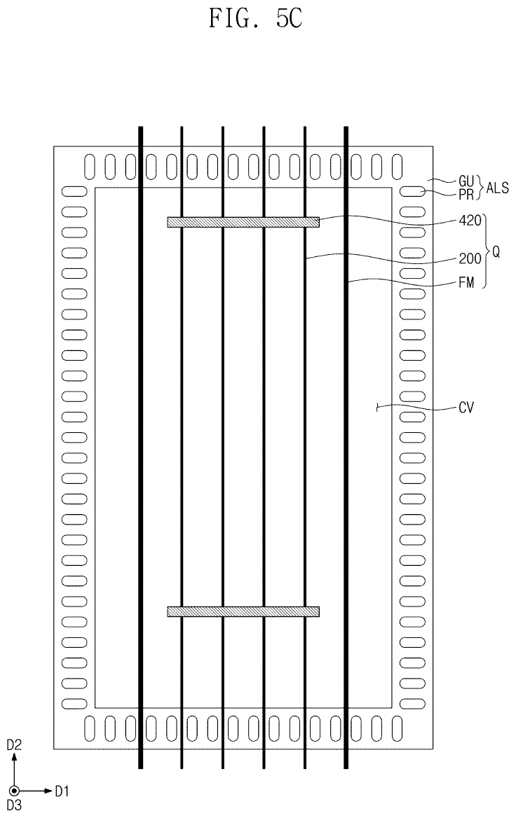

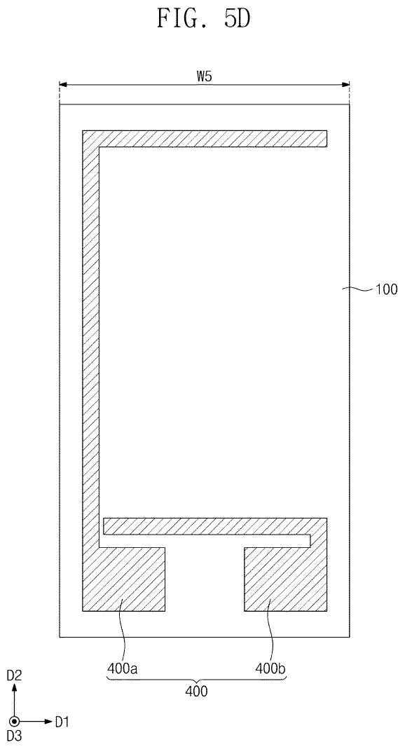

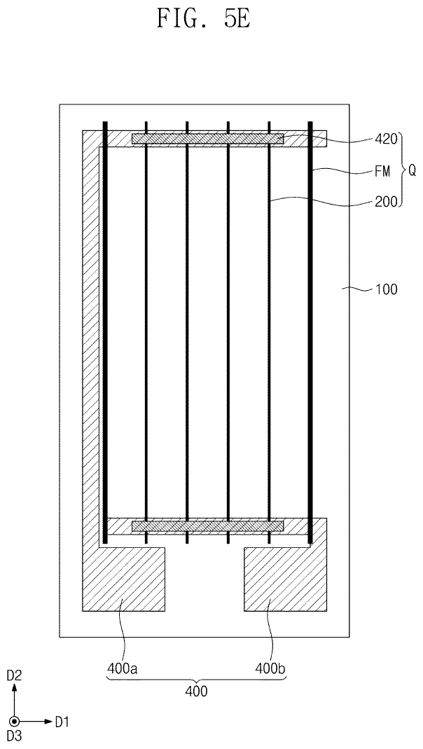

FIGS. 5A to 5E are diagrams sequentially illustrating a process of manufacturing the film actuator of FIG. 4 according to embodiments of the inventive concept.

Referring to FIG. 5A, a guide structure ALS may be prepared. The guide structure ALS may serve as a guide to arrange the fixed wires FM and the transformation wires 200 in desired directions and intervals. The guide structure ALS may have a rectangular ring shape having a cavity CV at a center thereof. The guide structure ALS may include a guide body GU and projections PR. The projections PR may be disposed on the guide body GU to be spaced apart in the first and second directions D1 and D2.

In the first direction D1, the guide structure ALS may have a first width W1. That is, a distance between outer walls of the guide body GU in the first direction D1 may be the first width W1. A distance between inner walls of the guide body GU in the first direction D1 may be a second width W2 smaller than the first width W1. That is, the cavity CV of the guide structure ALS may have the second width W2 in the first direction D1.

The transformation wires 200 may be disposed on the guide structure ALS. The transformation wires 200 may be arranged to be spaced apart from each other in the first direction D1. Each transformation wire 200 may be disposed between different projections PR. Due to the projections PR, the transformation wires 200 may be spaced apart and aligned.

Line patterns 420 may be disposed over the transformation wires 200 aligned on the guide structure ALS. The line patterns 420 may include, for example, two or more patterns. Each line pattern 420 may be positioned between different projections PR. Due to the projections PR, the line patterns 420 may be aligned to be spaced apart from each other. The line patterns 420 may be spaced apart from each other in the second direction D2 so as to intersect the transformation wires 200. The line patterns 420 may have a third width W3 greater than the first width W1 in the first direction D1.

Referring to FIG. 5B, the transformation wire 200 and the line pattern 420 may be pressed using a press so as to be combined with each other. Thereafter, the line patterns 420 may be cut. The cut line patterns 420 may have a fourth width W4 smaller than the second width W2 in the first direction D1. Thus, an array of the transformation wires 200 having electrical contacts generated at desired positions may be provided. A role of the line patterns 420 may be an electrical connection path for multi-channel driving of the transformation wires 200. Since the transformation wires 200 may have difficulty in being directly electrically connected due to their characteristics, the transformation wires 200 may be electrically connected to a conductive pattern 400 to be described below through the line patterns 420.

Referring to FIG. 5C, the fixed wires FM may be disposed on the guide structure ALS. Each fixed wire FM may be disposed between different projections PR. Due to the projections PR, the fixed wires FM may be aligned to be spaced apart from each other. The fixed wires FM may be arranged to be spaced apart from one another in the first direction D1 and to be spaced apart from the transformation wires 200. For example, the fixed wires FM may be disposed one on each side of the array of the transformation wires 200. The fixed wires FM may be spaced apart from the line patterns 420 and may not be in contact with the line patterns 420. Thus, a wire array structure Q may be provided.

Referring to FIG. 5D, a substrate 100 having the conductive pattern 400 provided thereon may be prepared. The substrate 100 may have a fifth width W5 in the first direction D1. The fifth width W5 may be less than or equal to the second width W2 of the cavity CV of the guide structure ALS. For example, the fifth width W5 may be from about 0.9 times to about 1.0 times the second width W2. The conductive pattern 400 may include a first electrode pad 400a and a second electrode pad 400b. The conductive pattern 400 may extend in the first and second directions D1 and D2 on the substrate 100. The conductive pattern 400 may be used as a multi-channel path for applying current to the transformation wires 200.

Referring to FIG. 5E, the wire array structure Q of FIG. 5C may be aligned on the substrate 100. As described with reference to FIGS. 5B and 5D, a fifth width W5 of the substrate 100 may be less than or equal to a second width W2 of the cavity CV of the guide structure ALS. Accordingly, the wire array structure Q may be aligned on the substrate 100 so that the substrate 100 is disposed in the cavity CV. After the line patterns 420 are aligned with positions of the conductive pattern 400, the guide structure ALS may be removed. Thereafter, the line patterns 420 may be attached to the conductive pattern 400 with a conductive adhesive, and the transformation wires 200 and the fixed wires FM may be cut to an appropriate length. After drying of the conductive adhesive is completed, fixing blocks 300 may be formed to cover a portion of the conductive pattern 400, a portion of the transformation wire 200, and a portion of the fixed wire FM, thereby forming the film actuator P′ of FIG. 4. The fixing blocks 300 may be spaced apart from one another in the second direction D2. Thereafter, an external power supply may be connected to the first and second electrode pads 400a and 400b to control desired channels.

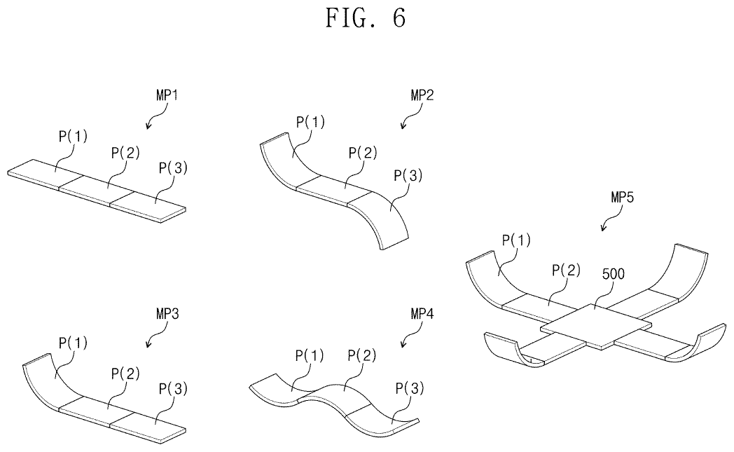

FIG. 6 illustrates perspective views of multi-channel film actuators according to embodiments of the inventive concept.

Referring to FIG. 6, first to fourth multi-channel film actuators MP1, MP2, MP3, and MP4 may be film actuators constituted with three channels. Each of the first to fourth multi-channel film actuators MP1, MP2, MP3, and MP4 may include first to third portions P (1), P (2), and P (3). Each of the first to third portions P (1), P (2), and P (3) may be the film actuator P of FIG. 1 or the film actuator P′ of FIG. 4. Alternatively, each of the first to fourth multi-channel film actuators MP1, MP2, MP3, and MP4 may be the film actuator P of FIG. 1 or the film actuator P′ of FIG. 4. The first to third portions P (1), P (2), and P (3) may be bent in a desired direction. The first to third portions P (1), P (2), and P (3) deformed in this manner may maintain a permanently fixed state even without current being applied.

A fifth multi-channel film actuator MP5 may include a main part 500 and first and second portions P (1) and P (2). The first and second portions P (1) and P (2) may be connected to sides of the main part 500, respectively. The main part 500 may include, for example, wiring and may control the first and second portions P (1) and P (2). The fifth multi-channel film actuator MP5 may be provided in various directions and shapes, thereby enabling more complex shape-variable fixation.

The film actuator according to the inventive concept may fix the shape of the film actuator without power consumption, and complex shape deformation may be enabled through multi-channel control. As a result, the energy efficiency and stability of the film actuator may be improved.

Although the embodiments of the present invention have been described, it is understood that the present invention should not be limited to these embodiments, but various changes and modifications can be made by one ordinary skilled in the art within the spirit and scope of the present invention as hereinafter claimed.

What is claimed is:

1. A film actuator comprising:
a substrate;
transformation wires disposed on the substrate to be spaced apart from each other in a first direction parallel to the substrate;
fixed wires disposed to be spaced apart from the transformation wires in the first direction and disposed on both sides of the transformation wires, respectively; and
fixing blocks disposed on the transformation wires and the fixed wires to be spaced apart from each other in a second direction parallel to the substrate and intersecting the first direction,
wherein the transformation wires comprise a shape memory alloy.

2. The film actuator of claim 1, wherein the transformation wires and the fixed wires respectively extend in the second direction.

3. The film actuator of claim 1, wherein a portion of each of the transformation wires and a portion of each of the fixed wires are exposed between the fixing blocks.

4. The film actuator of claim 1, wherein the shape memory alloy comprises nitinol, which is an alloy of nickel and titanium.

5. The film actuator of claim 1, wherein the fixing blocks comprise at least one of a photosensitive adhesive, a photosensitive resin, or a thermosetting resin.

6. The film actuator according to claim 1, wherein the fixed wires comprise at least one of gold, silver, copper, or aluminum.

7. The film actuator of claim 1, wherein each of the transformation wires has a first thickness in a third direction perpendicular to the substrate,
each of the fixed wires has a second thickness, and
the second thickness is greater than the first thickness.

8. The film actuator of claim 1, wherein the substrate includes at least one of polyethylene terephthalate (PET), polyimide (PI), polyethylene naphthalate (PEN), polydimethylsiloxane (PDMS), or parylene.

9. The film actuator of claim 1, wherein the substrate comprises a top surface and a bottom surface opposite to each other,
the transformation wire further comprises an upper transformation wire disposed on the top surface of the substrate and a lower transformation wire disposed on the bottom surface of the substrate, and
a voltage is selectively applied to the upper transformation wire or the lower transformation wire.

10. A film actuator comprising:
a substrate;
transformation wires disposed on the substrate to be spaced apart from each other in a first direction parallel to the substrate;
fixed wires disposed to be spaced apart from the transformation wires in the first direction and disposed on both sides of the transformation wires, respectively;
a conductive pattern disposed on the substrate and electrically connected to the transformation wires; and
fixing blocks disposed on the transformation wires, the fixed wires, and the conductive pattern to be spaced apart from each other in a second direction parallel to the substrate and intersecting the first direction,
wherein each of the transformation wire comprises a shape memory alloy, and
a portion of each of the transformation wires and a portion of each of the fixed wires are exposed between the fixing blocks.

11. The film actuator of claim 10, wherein the shape memory alloy comprises nitinol, which is an alloy of nickel and titanium, and
each of the fixed wires comprises at least one of gold, silver, copper, or aluminum.

12. A method for manufacturing a film actuator, comprising:
preparing a guide structure comprising a guide body and projections disposed on the guide body to be spaced apart from each other;
placing transformation wires on the guide structure;
placing line patterns on the transformation wires and pressing the transformation wires and the line patterns;
cutting the line patterns;
placing fixed wires on the guide structure to form a wire array structure; and
aligning the wire array structure on a substrate.

13. The method for manufacturing the film actuator of claim 12, wherein the guide body has a rectangular ring shape having a cavity at a center thereof,
the guide body has a first width in a first direction, and
the cavity has a second width smaller than the first width in the first direction.

14. The method of manufacturing the film actuator of claim 13, wherein before the cutting of the line patterns, each of the line patterns has a third width greater than the first width in the first direction.

15. The method of manufacturing the film actuator of claim 13, wherein after the cutting of the line patterns, each of the cut line patterns has a fourth width smaller than the second width in the first direction.

16. The method of manufacturing the film actuator of claim 13, wherein the aligning of the wire array structure on the substrate comprises aligning the substrate so that the substrate is disposed in the cavity.

17. The method of manufacturing the film actuator of claim 12, wherein the transformation wires are spaced apart from each other in the first direction and disposed between different projections, and
the line patterns are spaced apart from each other in a second direction intersecting the first direction.

18. The method of manufacturing a film actuator of claim 17, wherein the forming of the wire array structure comprises:
placing the fixed wires on both sides of the array of the transformation wires in the first direction to be spaced apart from the transformation wires; and
placing the fixed wires to be spaced apart from the cut line patterns.

19. The method of manufacturing a film actuator of claim 12, wherein the substrate comprises a conductive pattern, and
the method further comprises:
attaching the line patterns to the conductive pattern; and
forming fixing blocks configured to cover a portion of the conductive pattern, a portion of the transformation wires, and a portion of the fixed wires.
